(19) United States
(12) Patent Application Publication
(10) Pub. No.: US 2026/0131669 A1
(43) Pub. Date: May 14, 2026

(54) MANUAL TORQUE VECTORING USING STEERING WHEEL-MOUNTED INPUT DEVICES

(71) Applicant: Rivian IP Holdings, LLC, Irvine, CA (US)

(72) Inventor: Mason VERBRIDGE, Canton, MI (US)

(21) Appl. No.: 19/355,892

(22) Filed: Oct. 10, 2025

Related U.S. Application Data
(60) Provisional application No. 63/718,512, filed on Nov. 8, 2024.

(51) Int. Cl. B60L 15/20; B60L 3/10

(52) U.S. Cl. CPC B60L 15/2036; B60L 3/106; B60L 2240/24; B60L 2240/429; B60L 2240/463; B60L 2250/26

(57) ABSTRACT

A vehicle includes a controller configured to calculate initial torques for a plurality of road wheels of a vehicle and receive a manual input instructing one or more torque differentials for the initial torques. The controller adjusts the initial torques according to the one or more torque differentials to obtain output torques and drives the plurality of road wheels according to the output torques. The manual input may be received from input devices mounted to a steering wheel, such as two input wheels. The controller may adjust a left to right torque distribution between right and left wheels of the vehicle according to the manual input.

### RELATED APPLICATION

This application claims priority to U.S. Provisional Application Ser. No. 63/718,512 filed Nov. 8, 2024, and entitled MANUAL TORQUE VECTORING USING STEERING WHEEL-MOUNTED INPUT DEVICES, which is hereby incorporated herein by reference in its entirety.

### INTRODUCTION

The present disclosure relates to performing torque vectoring using steering wheel-mounted input devices.

### SUMMARY

In one aspect, a vehicle controller is configured to calculate initial torques for a plurality of road wheels of a vehicle and receive a manual input instructing one or more torque differentials for the initial torques. The vehicle controller adjusts the initial torques according to the one or more torque differentials to obtain output torques and drives the plurality of road wheels according to the output torques.

In some embodiments, vehicle controller is configured to receive the manual input from one or more input devices mounted to a steering wheel of the vehicle.

In some embodiments, the one or more input devices include two input devices.

In some embodiments, the two input devices include two input wheels.

In some embodiments, the plurality of road wheels includes one or more left wheels and one or more right wheels, the vehicle controller further configured to adjust a torque distribution between the one or more left wheels and the one or more right wheels according to the one or more torque differentials.

In some embodiments, the vehicle controller is further configured to drive the plurality of road wheels by controlling current to a plurality of motors, the plurality of motors including one or more left motors coupled to the one or more left wheels and one or more right motors coupled to the one or more right wheels.

In some embodiments, the vehicle controller is further configured to calculate the initial torques according to at least one of a position of a steering wheel, a position of an accelerator pedal, and a position of a brake pedal.

In some embodiments, the vehicle controller is further configured to calculate the initial torques according to at least one of an output of a stability control algorithm and an output of a traction control algorithm.

In some embodiments, the vehicle controller is further configured to calculate the initial torques according to a self-driving algorithm.

In another aspect, a vehicle includes a plurality of road wheels, a steering wheel, and one or more manual input devices mounted to the steering wheel. The vehicle includes a controller configured to calculate initial torques for the plurality of road wheels and receive a manual input from the one or more manual input devices instructing one or more torque differentials for the initial torques. The controller adjusts the initial torques according to the one or more torque differentials to obtain output torques and drives the plurality of road wheels according to the output torques.

In some embodiments, the one or more manual input devices include two manual input devices.

In some embodiments, the two manual input devices include two input wheels.

In some embodiments, the plurality of road wheels includes one or more left road wheels and one or more right road wheels. The controller may be further configured to adjusts a torque distribution between the one or more left road wheels and the one or more right road wheels according to the one or more torque differentials.

In some embodiments, the vehicle further includes a plurality of motors coupled to the plurality of road wheels, wherein the controller is further configured to drive the plurality of road wheels by controlling current to the plurality of motors, the plurality of motors including one or more left motors coupled to the one or more left road wheels and one or more right motors coupled to the one or more right road wheels.

In some embodiments, the vehicle further includes an accelerator pedal and a brake pedal, the controller being further configured to calculate the initial torques according to at least one of a position of the steering wheel, a position of the accelerator pedal, and a position of the brake pedal.

In some embodiments, the controller is further configured to calculate the initial torques according to at least one of an output of a stability control algorithm and an output of a traction control algorithm.

In some embodiments, the controller is further configured to calculate the initial torques according to a self-driving algorithm.

In another aspect, a non-transitory computer-readable medium storing executable code that, when executed by a vehicle controller, causes the vehicle controller to calculate initial torques for a plurality of road wheels of a vehicle and receive a manual input instructing one or more torque differentials for the initial torques. The initial torques are adjusted according to the one or more torque differentials to obtain output torques. The plurality of road wheels is driven according to the output torques.

In some embodiments, the executable code, when executed by the vehicle controller, further causes the vehicle controller to receive the manual input from two input wheels.

In some embodiments, the plurality of road wheels includes one or more left road wheels and one or more right road wheels, the executable code, when executed by the vehicle controller, further causes the vehicle controller to adjust a torque distribution between the one or more left road wheels and the one or more right road wheels according to the one or more torque differentials.

### BRIEF DESCRIPTION OF THE DRAWINGS

FIG. 1A illustrates an example vehicle in accordance with certain embodiments.

FIG. 1B illustrates a chassis of a vehicle in accordance with certain embodiments.

FIG. 2A is a schematic block diagram of components of a vehicle in accordance with certain embodiments.

FIG. 2B is a schematic block diagram of alternative components of a vehicle in accordance with certain embodiments.

FIG. 3 illustrates a steering wheel having input devices mounted thereto that may be used for manual torque vectoring in accordance with certain embodiments.

FIGS. 4A and 4B illustrate layouts of motors of a vehicle in accordance with certain embodiments.

FIG. 5 illustrates generating a torque based on inputs to steering-wheel mounted controls in accordance with certain embodiments.

### DETAILED DESCRIPTION

Three- and four-motor vehicles enable independent control of the torque supplied to right and left sides of a vehicle. This ability is used to control stability and perform torque vectoring to improve handling of the vehicle. Using the approach described herein, a user provides inputs to input devices mounted to the steering wheel in order to manually adjust the amount of torque supplied to right and left road wheels of the vehicle. This ability may be used when off-roading, to implement tank drive, or other applications.

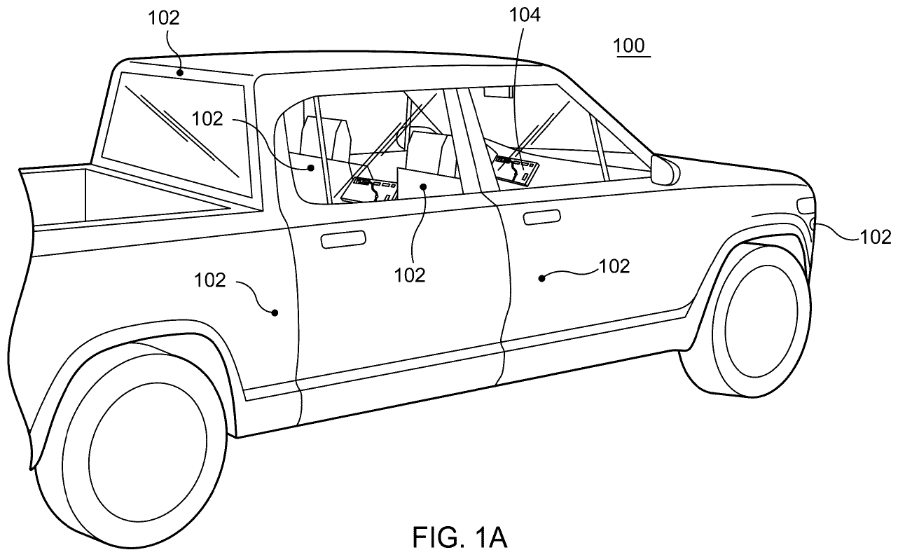

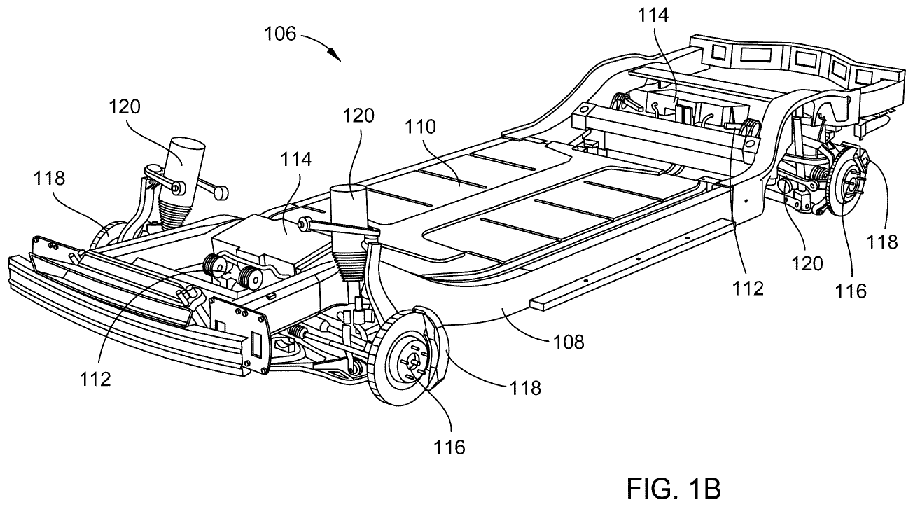

FIG. 1A illustrates an example vehicle 100. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (i.e., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear reduction drive. In some embodiments, there is a single drive unit 112 driving either the front road wheels or the rear road wheels of the vehicle 100. In another embodiment, there are two drive units 112, each driving either the front road wheels or the rear road wheels of the vehicle 100. In yet another embodiment, there are four drive units 112, each drive unit 112 driving one of four road wheels of the vehicle 100. In yet another embodiment, one drive unit 112 (e.g. the front drive unit) includes a single motor and another drive unit 112 (e.g., the rear drive unit) includes two motors, each driving one wheel.

Power from the battery 110 may be supplied to the drive units 112 by one or more sets of power electronics 114. The power electronics 114 may include inverters configured to convert direct current (DC) from the battery 110 into alternating current (AC) supplied to the motors of the drive units 112.

The drive units 112 are coupled to two or more hubs 116 to which road wheels may mount. Each hub 116 includes a corresponding brake 118, such as the illustrated disc brakes. The drive units 112 or other component may also provide regenerative braking. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B and in the discussion below, the vehicle 100 is a battery electric vehicle. However, the systems and methods disclosed herein may be used for any type of vehicle, including vehicles powered by an internal combustion engine (ICE), hybrid drivetrain, hydrogen fuel cell drivetrain, or other type of drivetrain that requires heating in preparation for use, such as diesel engines.

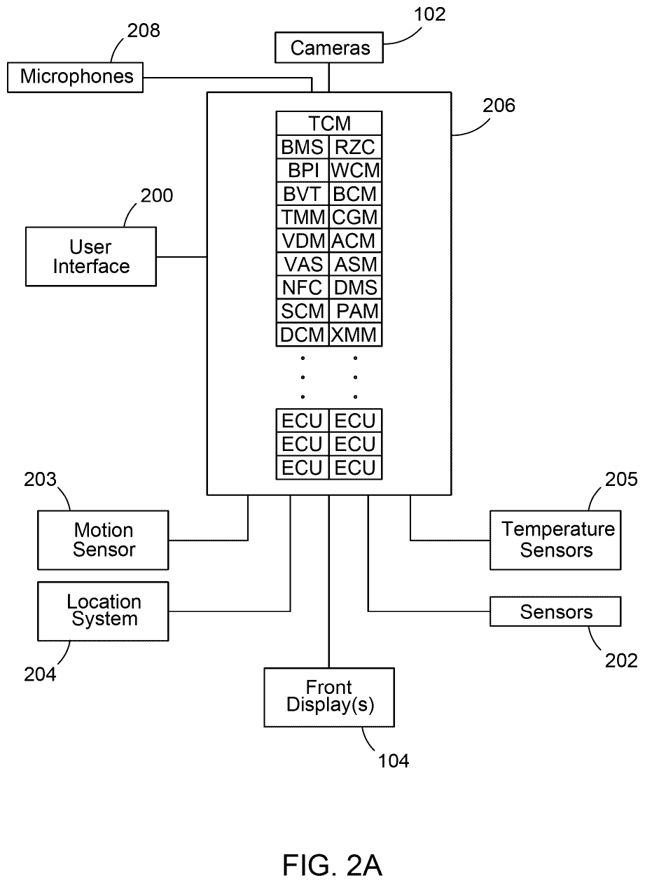

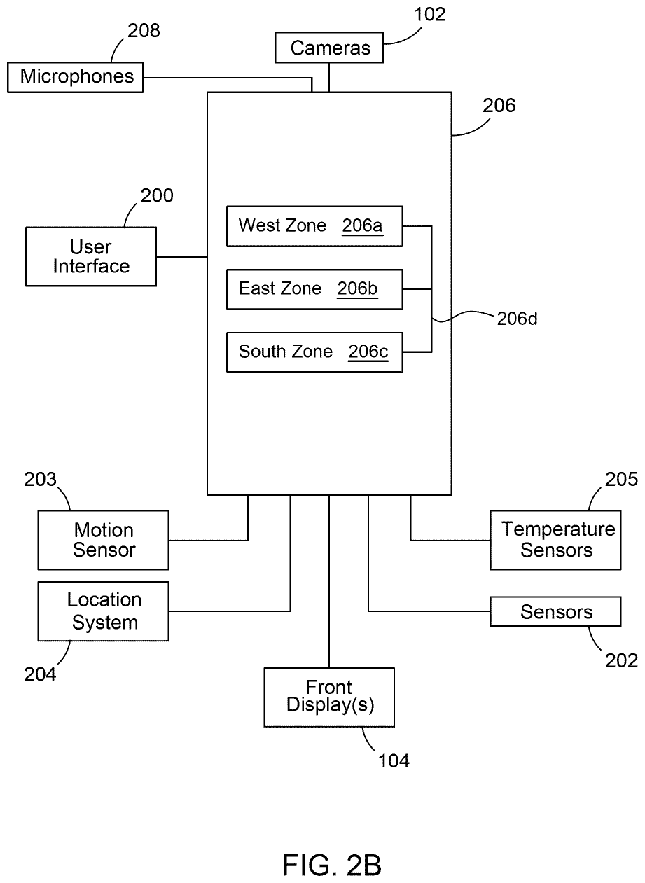

FIG. 2A illustrates example components of the vehicle 100 of FIG. 1A. As shown in FIG. 2A, the vehicle 100 includes the cameras 102, the one or more front displays 104, a user interface 200, one or more sensors 202, a motion sensor 203, and a location system 204. The one or more sensors 202 may include ultrasonic sensors, radio detection and ranging (RADAR) sensors, light detection and ranging (LIDAR) sensors, or other types of sensors. The location system 204 may be implemented as a global positioning system (GPS) receiver. The user interface 200 allows a user, such as a driver or passenger in the vehicle 100, to provide input.

The components of the vehicle 100 may include one or more temperature sensors 205. The temperature sensors 205 may include sensors configured to sense an ambient air temperature, temperature of the battery 110, temperature of power electronics 114, temperature of each drive unit 112 and/or each motor of each drive unit 112, or the temperature of any other component of the vehicle 100.

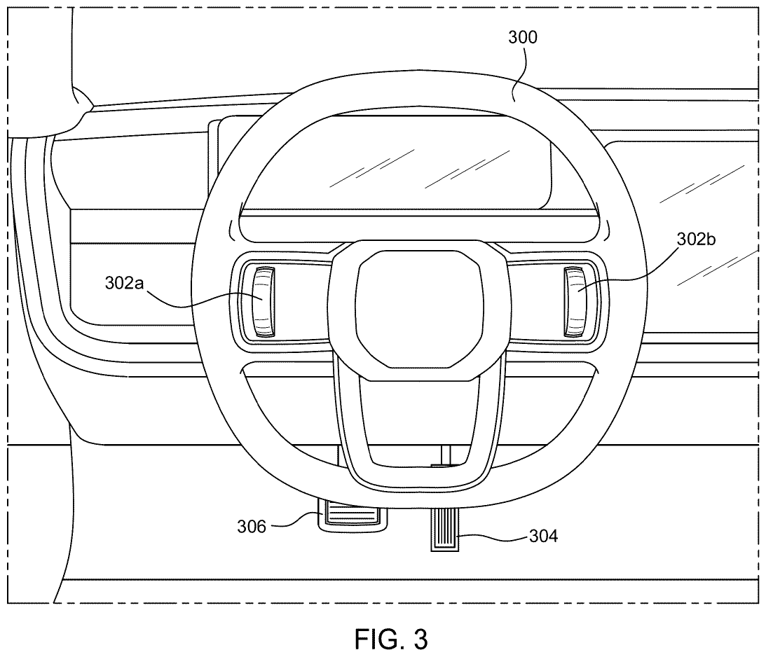

A control system 206 executes instructions to perform at least some of the actions or functions of the vehicle 100, including the functions described in relation to FIGS. 3 to 5. For example, as shown in FIG. 2, the control system 206 may include one or more electronic control units (ECUs) configured to perform at least some of the actions or functions of the vehicle 100, including the functions described in relation to FIGS. 3 to 5. In certain embodiments, each of the ECUs is dedicated to a specific set of functions. Each ECU may be a computer system and each ECU may include functionality described below in relation to FIGS. 3 to 5.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle's communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102 and sensors 202. The sensor signals collected by the CGM ECU are then communicated to the appropriate ECUs for performing, for example, the operations and functions described in relation to FIGS. 3 to 5.

The control system 206 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU. If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 208, etc.) to the TCM ECU.

Referring to FIG. 2B, in some embodiments, the control system 206 may be implemented as a plurality of zonal controllers 206a, 206b, 206c. Each zonal controller 206a, 206b, 206c may control a subset of systems of the vehicle. The subset of systems controlled by each zonal controller 206a, 206b, 206c may be generally assigned based on location within the vehicle 100. For example, a west zonal controller 206a may control systems on a driver side of the vehicle 100, an east zonal controller 206b may control systems on a passenger side of the vehicle 100, and a south zonal controller 206c may control systems in a rear portion of the vehicle. Each zonal controller 206a, 206b, 206c may implement a portion of the functions ascribed to the ECUs of the control system 206 of FIG. 2A. The functions of the ECUs may be distributed among the zonal controller 206a, 206b, 206c such that only one zonal controller 206a, 206b, 206c implements the functions of each ECU. Alternatively, the functions of an ECU may be duplicated across multiple zonal controllers 206a, 206b, 206c, each zonal performing the functions of the ECU for the portion of the vehicle to which that zonal controller 206a, 206b, 206c is assigned.

The zonal controllers 206a, 206b, 206c may be connected to one another by a network 206d, such as an Ethernet network, controller area network (CAN), or other type of network.

Referring to FIG. 3, a vehicle 100 may include a steering wheel 300, steering yoke, steering lever, or other type of interface for a user to provide steering inputs to the vehicle. The steering wheel 300 may be coupled to the steered road wheels of the vehicle 100 by a linkage or may be part of a steer-by-wire system in which the steering wheel 300 position is sensed and used to generate electrical signals for controlling an actuator controlling the angle of steered road wheels of the vehicle 100. The steering wheel 300 may have a range of rotation that is 180 degrees or less on either side of a centered position of the steering wheel 300. This may be particularly useful in a steer-by-wire system in which the steering ratio between the position of the steering wheel 300 and the steered road wheels can be varied based on vehicle speed or drive mode (e.g., a “performance mode” may have a higher steering ratio relative to another drive mode).

The steering wheel 300 may have left and right input devices 302a, 302b, respectively, mounted thereto. The input devices 302a, 302b may be haptic feedback devices that may be deflected or moved by a driver while providing a feedback feel, such as resistance to movement, a restoring force in response to movement, palpable clicks or taps in response to movement, or other haptic feedback. The input devices 302a, 302b may be embodied as input wheels and corresponding motors that are controlled to provide the feedback feel. The input wheels may have axes of rotation substantially (e.g., within 10 degrees of) parallel to one another and substantially (e.g., within 10 degrees of) perpendicular to the axis of rotation of the steering wheel 300 and positioned on either side of the axis of rotation of the steering wheel 300. In vehicles 100 with electronic steering (e.g., steer by wire), the steering wheel may have a limited range of motion as noted above. Accordingly, the input devices 302a, 302b may remain in consistent and intuitive positions relative to the driver, thereby enabling instinctive control of right-side and left-side behavior using the input devices 302a, 302b as described below.

The vehicle cabin further includes an accelerator pedal 304 that may be pressed or released to communicate a desired amount of acceleration. The vehicle cabin may include a brake pedal 306 for invoking regenerative and/or friction braking. In some embodiments, a single pedal 304 is used, with pressing of the pedal invoking acceleration and releasing of the pedal invoking deceleration.

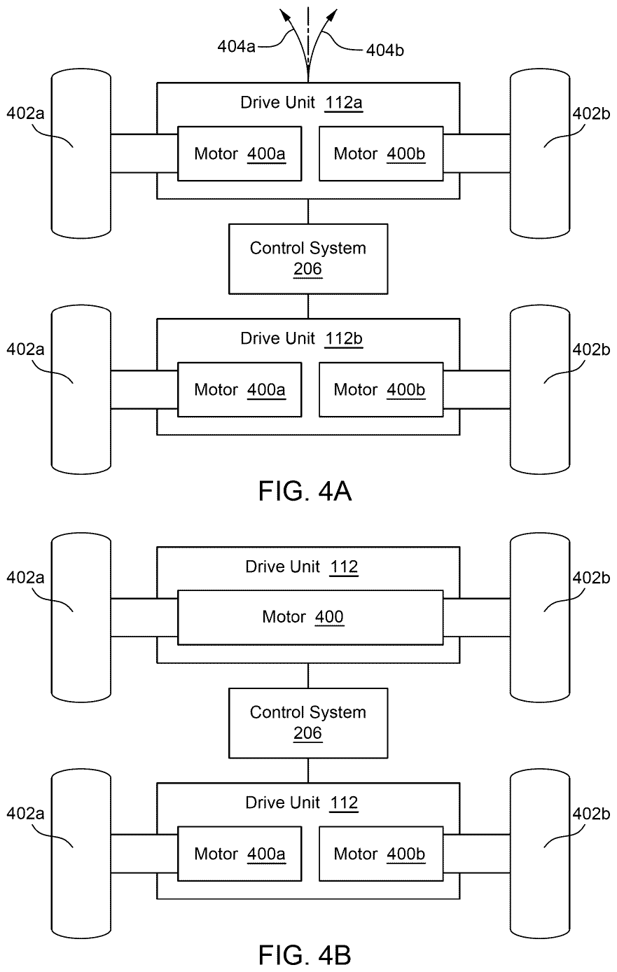

Referring to FIG. 4A, the drive units 112 may include a front drive unit 112a and a rear drive unit 112b. The vehicle 100 may be a quad-motor vehicle including two motors 400a, 400b in each drive unit 112a, 112b driving left and right road wheels 402a, 402b, respectively, that are attached to that drive unit 112a, 112b. Alternatively, the front or rear drive unit 112a, 112b may include a single motor 400 driving both left and right road wheels as shown in FIG. 4B.

By controlling the different torque adjustments to left and right side motors 400a, 400b using the approach described herein, a left/right (L/R) torque imbalance may be created that induces a leftward adjustment 404a or a rightward adjustment 404b to the trajectory of the vehicle 100.

In the examples below, control of the torque applied to the left and right sides of the vehicle is performed by controlling current supplied to the motors 400a, 400b, respectively. However, other approaches are possible. In particular, any torque vectoring approach known in the art, such as using a single motor (or engine), drive shafts, and clutches to control the supply of power to each road wheel as known in the art.

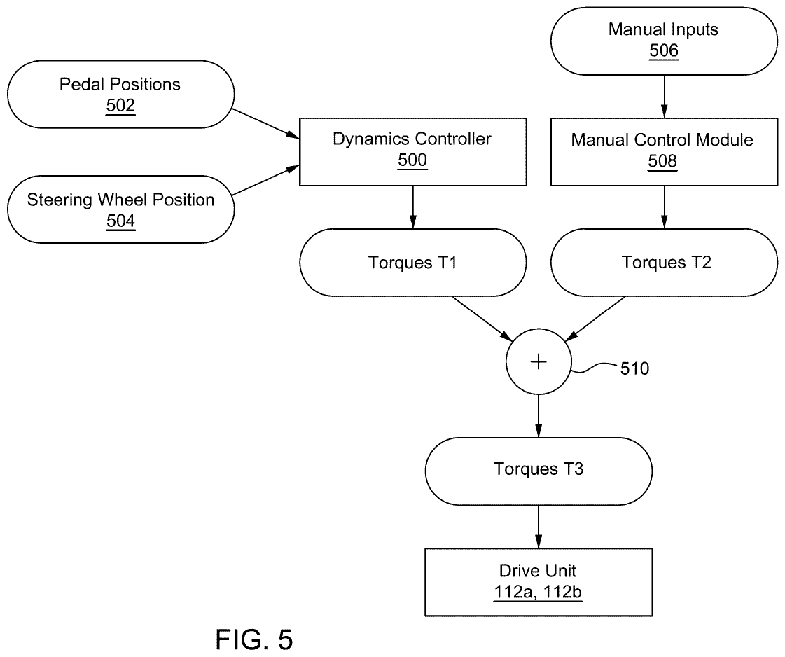

Referring to FIG. 5, in some embodiments, the control system 206 includes a dynamics controller 500. The dynamics controller 500 receives inputs such as pedal positions 502 of the pedals 304 306, a steering wheel position 504, and possibly other inputs, such as accelerometers, speed sensors, or the like. The dynamics controller 500 may determine a torque T1 to supply to each motor 400, 400a, 400b according to the inputs, e.g., initial torques T1. The dynamics controller 500 may seek to implement driver intent indicated by the pedal positions 502 and steering wheel position. The dynamics controller 500 may further select the torque T1 for each motor 400a, 400b according to a stability control algorithm, traction control algorithm, or automated driving assistance function (e.g., cruise control, dynamic cruise control, lane keep assist).

Manual inputs 506 received from the left input device 302a and/or right input device 302b may be received by a manual control module 508 and processed to obtain one or more torques T2 for each motor 400, e.g., a torque differential for some or all of the torques T1. The torque for a motor 400a, 400b may be a combination of the torque T1 and the torque T2 for that motor 400a, 400b. For example, a combination stage 510 may combine the torque T1 and the torque T2 for a motor 400a, 400b, such as by summing to obtain an output torque T3 for the motor 400a, 400b. The combination stage 510 may include other logic, such as constraining the output torque T3 to be no higher than a maximum torque. Note that any of the torques T1, T2, and T3 may be negative indicating regenerative braking using the motor 400a, 400b. A negative output torque on a road wheel 402a, 402b may also be achieved by activating the brake 118 of that road wheel 402a, 402b, such as by opening a valve to allow hydraulic fluid to compress a brake caliper or by activating an electric motor to compress the brake caliper.

In the absence of an input from an input device 302a, 302b corresponding to a motor 400a, 400b, the value of T2 may be set to zero either immediately following an input or as part of a gradual transition to zero.

The torque T3 for a motor 400a, 400b may be provided to the drive unit 112a, 112b including that motor 400a, 400b, which will then seek to cause the motor 400a, 400b to generate the commanded torque T3.

The approach of FIGS. 3 to 5 may be used to implement various use cases described below.

The input devices 302a, 302b may be used to provide an intuitive interface allowing the user to adjust the L/R torque distribution between left and right road wheels 402a, 402b, for one or both of the front pair of road wheels 402a, 402b and the rear pair of road wheels 402a, 402b. Mentally, the user can easily correlate their inputs to the steering wheel's haptic wheel to expected behavior of the associated (left vs. right) rear tires, easily dictating vehicle dynamic behavior: the left input device 302a invokes a torque differential applied to the left road wheels 402a, and the right input device 302b invokes a torque differential applied to the right road wheels 402b.

In a world where autonomy continues to impress with processing capability for “normal” driving, the actual driver's experience is diminished. Most of the miles/time, this is appreciated though the ability for autonomy to take away the monotony of daily commute driving tasks. Using the input devices 302a, 302b to control L/R torque distributions facilitates the driver's ability, skill, and desire to drive. With this level of precise control, in challenging environments, the driver can drive with excitement, passion, and intent while control system 206 of the vehicle 100 takes the brunt of driving responsibility.

In a first example use case, a “flick” of one or both input devices 302a, 302b embodied as wheels corresponds to a torque distribution (L/R) to replicate the driver's input. The direction of user input “spin” on the wheel dictates the adjustment to the respective (L/R) torque applied to road wheel 402a, 402b. For example, the “outside” road wheel in a turn will produce increased yaw with a forward torque input, and reduced yaw with a reverse input. The opposite is true for user input directions vs. vehicle response for the “inside” road wheel. Torque input in either direction (forward or reversed) is possible/desired as a user control for both road wheels 402a, 402b.

In a second example use case, dynamic “cogging” allows the user to “spin” the input devices 302a, 302b implemented as a wheel as fast/hard as they wish, allowing the user to control the amplitude of L/R torque bias by how hard/how fast they “spin” the wheels in the intended direction for each of the rear tires' torque deliver. “Cogging” may refer to a simulated detent or haptic feedback output at regular angular intervals as the wheel is spun.

In a third example use case, the input devices 302a, 302b provide a “spring” based control. The input devices 302a, 302b implemented as wheels may be biased to “return to center.” The angular distance and direction that a wheel is pushed from the center dictates the sign and magnitude of the torque T2 (and correspondingly the torque T3) for the side corresponding to that wheel, e.g., pushing the left wheel forward may increase torque applied to the left side road wheel 402a, pushing the right wheel forward may increase torque applied to the right side road wheel 402b, pushing the left wheel backward may decrease torque applied to the left side road wheel 402a, and pushing the right wheel backward may decrease torque applied to the right side road wheel 402b. Decreasing applied torque may include applying a negative torque using regenerative braking.

In a fourth example use case, inputs using the input devices 302a, 302b according to any of the foregoing embodiments, may be accompanied with haptic feedback using the input devices 302a, 302b indicating road wheel grip/slip based on real-time conditions to provide a closed loop mechanism to give better driver-in-loop feedback and precision in control of the behavior of left and right road wheels 402a, 402b and resulting vehicle response/behavior.

In a fifth example use case, when driving off road or in low traction situations (e.g., snow) at relatively high speeds (e.g., above 20 km/h), the user may adjust a vehicle slip angle before or during a corner. For example, a user may executing a “Scandinavian Flick” or perform attitude adjustment when driving in snow.

In a sixth example use case, when driving off road or in low traction situations at relatively low speeds (e.g., below 20 km/h), the user may invoke “bumps” of torque on the left or right side of the vehicle 100 in positive or negative direction to help the vehicle 100 crawl up rocks. The location of the inputs devices 302a, 302b allows user to stay stable on pedal input to control the average torque needed to climb and then invoke bumps of additional torque when a particular side/wheel encounters an obstacle using the inputs devices 302a, 302b. The manual control of torque may allow the user to more directly control vehicle 100 out of a “stuck” condition. For example, a left input device 302a may be rolled forward to increase torque on left road wheels 402a, and the right input device 302b may be rolled forward to increase torque on the right road wheels 402b.

In a seventh example use case, the vehicle 100 is driven on a high traction surface (high y). Adjusting the torque applied to the left and/or right side road wheels 402a, 402b enables the driver to adjust vehicle attitude, surge power to an individual road wheel, or request temporary regenerative braking with precise modulation on one or both road wheels 402a, 402b.

In an eighth example use case with a vehicle 100 configured as shown in FIG. 4A, tank turns may be executed using inputs to the input devices 302a, 302b. During a tank turn, wheels 402a turn in opposite direction from the wheels 402b and cause the vehicle 100 to turn. The driver may use the input devices 302a, 302b to manually control left, right, or both motors 400a, 400b, respectively, for more precise control of vehicle behavior.

In a ninth example use case, the input devices 302a, 302b are used to adjust the front to rear torque distribution. For example, one input devices 302a may be used to increase or decrease torque applied to the front wheels 402a, 402b and another input devices 302b may be used to increase torque applied to the rear wheels 402a, 402b.

In a tenth example use case, a user may actuate both user input devices 302a, 302b in the same direction (e.g., forward) in order to command a transitory increase or decrease in torque.

In an eleventh example use case, haptic feedback is provided through the user input devices 302a, 302b while the user is interacting therewith. For example, if a user is commanding a change in torque applied to a wheel 402a, 402b and the wheel slips, as detected by a traction control algorithm, feedback may be provided through the corresponding user input device 302a, 302b. For example, if a wheel 402a slips, user input device 302a may be caused to produce a haptic output, e.g., buzzing. If a wheel 402b slips, user input device 302b may be caused to produce a haptic output.

In a twelfth use case, any attribute affecting driving dynamics may be associated with one or both user input devices 302a, 302b, such as suspension damping, ride height, behavior of a stability control algorithm, behavior of a traction control algorithm, behavior of an antilock braking system, or the like. A driver may then use the user input devices 302a, 302b to dynamically change one or more attributes while driving by interacting with one or both user input devices 302a, 302b. Specifically, the user may rotate an input device 302a, 302b and invoke changing of an attribute according to any of the above-described examples in correspondence with the amount of rotation. Which attribute is adjusted by which input device 302a, 302b may be set according to inputs received by the control system 206 from a user.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a one or more computer processing devices. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Certain types of storage devices that include these mediums include: diskette, hard disk, random access memory (RAM), read only memory (ROM), erasable programmable read only memory (EPROM or Flash memory), static random access memory (SRAM), compact disc read only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, refers to non-transitory storage rather than transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but the storage device remains non-transitory during these processes because the data remains non-transitory while stored.

What is claimed is:

1. A vehicle controller, comprising:
at least one processor; and
a memory coupled to the at least one processor and storing instructions that, when executed by the at least one processor, cause the at least one processor to:
calculate initial torques for a plurality of road wheels of a vehicle;
receive a manual input instructing one or more torque differentials for the initial torques;
adjust the initial torques according to the one or more torque differentials to obtain output torques; and
drive the plurality of road wheels according to the output torques.

2. The vehicle controller of claim 1, wherein the at least one processor is configured to receive the manual input from one or more input devices mounted to a steering wheel of the vehicle.

3. The vehicle controller of claim 2, wherein the one or more input devices include two input devices.

4. The vehicle controller of claim 3, wherein the two input devices include two input wheels.

5. The vehicle controller of claim 1, wherein the plurality of road wheels includes one or more left wheels and one or more right wheels, wherein the instructions further cause the at least one processor to adjust a torque distribution between the one or more left wheels and the one or more right wheels according to the one or more torque differentials.

6. The vehicle controller of claim 5, wherein the at least one processor is configured to drive the plurality of road wheels by controlling current to a plurality of motors, the plurality of motors including one or more left motors coupled to the one or more left wheels and one or more right motors coupled to the one or more right wheels.

7. The vehicle controller of claim 1, wherein the at least one processor is configured to calculate the initial torques according to at least one of a position of a steering wheel, a position of an accelerator pedal, and a position of a brake pedal.

8. The vehicle controller of claim 1, wherein the at least one processor is configured to calculate the initial torques according to at least one of an output of a stability control algorithm and an output of a traction control algorithm.

9. The vehicle controller of claim 1, wherein the at least one processor is configured to calculate the initial torques according to a self-driving algorithm.

10. A vehicle comprising:
a plurality of road wheels;
a steering wheel;
one or more manual input devices mounted to the steering wheel; and
a controller configured to:
calculate initial torques for the plurality of road wheels;
receive a manual input from the one or more manual input devices instructing one or more torque differentials for the initial torques;
adjust the initial torques according to the one or more torque differentials to obtain output torques; and
drive the plurality of road wheels according to the output torques.

11. The vehicle of claim 10, wherein the one or more manual input devices include two manual input devices.

12. The vehicle of claim 11, wherein the two manual input devices include two input wheels.

13. The vehicle of claim 10, wherein:
the plurality of road wheels includes one or more left road wheels and one or more right road wheels; and
the controller is further configured to adjust a torque distribution between the one or more left road wheels and the one or more right road wheels according to the one or more torque differentials.

14. The vehicle of claim 13, further comprising a plurality of motors coupled to the plurality of road wheels, wherein the controller is configured to drive the plurality of road wheels by controlling current to the plurality of motors, the plurality of motors including one or more left motors coupled to the one or more left road wheels and one or more right motors coupled to the one or more right road wheels.

15. The vehicle of claim 10, further comprising an accelerator pedal and a brake pedal, the controller being configured to calculate the initial torques according to at least one of a position of the steering wheel, a position of the accelerator pedal, and a position of the brake pedal.

16. The vehicle of claim 10, wherein the controller is configured to calculate the initial torques according to at least one of an output of a stability control algorithm and an output of a traction control algorithm.

17. The vehicle of claim 10, wherein the controller is configured to calculate the initial torques according to a self-driving algorithm.

18. A non-transitory computer-readable medium storing executable code that, when executed by a vehicle controller, causes the vehicle controller to:
calculate initial torques for a plurality of road wheels of a vehicle;
receive a manual input instructing one or more torque differentials for the initial torques;
adjust the initial torques according to the one or more torque differentials to obtain output torques; and
drive the plurality of road wheels according to the output torques.

19. The non-transitory computer-readable medium of claim 18, the executable code, when executed by the vehicle controller, further causes the vehicle controller to receive the manual input from two input wheels.

20. The non-transitory computer-readable medium of claim 18, wherein the plurality of road wheels include one or more left road wheels and one or more right road wheels, the executable code, when executed by the vehicle controller, further causes the vehicle controller to adjust a torque distribution between the one or more left road wheels and the one or more right road wheels according to the one or more torque differentials.
